(19) United States
(12) Patent Application Publication
(10) Pub. No.: US 2010/0270124 A1
(43) Pub. Date: Oct. 28, 2010

(54) PLANT PRODUCT CONVEYOR SYSTEM AND METHOD

(75) Inventors: Richard D. Heck, Lucerne Valley, CA (US); David E. Gadea, Loma Linda, CA (US)

Correspondence Address: SUGHRUE MION, PLLC, 2100 PENNSYLVANIA AVENUE, N.W., SUITE 800, WASHINGTON, DC, 20037, US

(73) Assignee: SUNKIST GROWERS, INC., Sherman Oaks, CA (US)

(21) Appl. No.: 12/682,562

(22) PCT Filed: Oct. 8, 2008
(86) PCT No.: PCT/US08/79133

§ 371 Date: May 13, 2010

Related U.S. Application Data
(60) Provisional application No. 60/978,885, filed on Oct. 10, 2007.

(51) Int. Cl. B65G 37/00; B65G 25/00

(52) U.S. Cl. 198/468.6; 198/468.01

(57) ABSTRACT

A conveyor method and apparatus for transporting and presenting plant products, such as fruit, vegetables, or similar articles, to a pick-up device on a packing machine which packs plant products in cartons by layer. The conveyor comprises a frame, a set of pulleys and belts within the frame, and a set of pre-formed, interchangeable pattern plates that are readily replaceable by alternative pattern plates. The method comprises loading the pre-formed, interchangeable pattern plates at a loading end of the conveyor and transporting them to a pick-up end of the conveyor where the articles are unloaded by a pick-up head on a packing machine.

This application claims priority from U.S. Provisional Application No. 60/978,885, filed Oct. 10, 2007, the entire content of which is incorporated by reference.

### FIELD OF THE INVENTION

Illustrative, non-limiting embodiments of the present invention relate generally to a plant product conveyor system, using interchangeable pattern plates that efficiently transports and presents plant products, such as fruits or vegetables, to a packing machine that picks up and packs the plant products into cartons by layer.

### BACKGROUND OF THE INVENTION

Many current packing machines for plant products, particularly fruit and vegetables, utilize a pick-up head which picks up one fruit or vegetable at a time and places it into a carton or similar package. The pick-up head cannot pick up more than one product at a time because, typically, the products are presented to it in a disorganized manner. As a result, these machines tend to have a low production rate, as each product is packed one at a time.

Other packing machines utilize an inclined plane, and the plant products roll down the plane to a feeding station for packing. Oblate fruits, such as tangerines, are quite likely to have a rough roll, and the resulting rough rolling or bouncing bruises the fruit. Moreover, plant products that are not packed with a pick-up head are more likely to be subject to bruising, and this bruising accelerates the rotting time of the food.

U.S. Pat. No. 6,185,915 to Chang discloses a fruit-packing machine that places fruit one by one using a fruit conveyor. The fruit conveyor may be moveable or may be arranged in an inclined manner to release the fruit one by one. Disadvantages of such a system include (i) a low production rate in packing the fruit, (ii) bruising the fruit as it rolls down an inclined conveyor, and (iii) limitations to packing only spherical, as opposed to odd shaped, fruit where the device relies on smooth rotation of the fruit as it rolls down the inclined conveyor.

Current feed systems for packing machines are often designed to pack one size of plant product or to pack plant product into one size of carton or package. Modifying the packing machine to work with a different size plant product or carton is inefficient because current packing machines have components that are heavy and difficult change out quickly when changing product or carton sizes.

The present invention, as embodied in the non-limiting and exemplary embodiments disclosed herein, overcomes or avoids such problems, and provides a flexible and efficient plant product conveyor system and method.

### SUMMARY OF ILLUSTRATIVE EMBODIMENTS OF THE INVENTION

Illustrative, non-limiting embodiments of the present invention overcome various disadvantages and problems of the foregoing. In addition, the present invention is not required to overcome these disadvantages, and an illustrative, non-limiting embodiment of the present invention may not overcome any problems, but may simply provide another way of performing a method or achieving a desired result.

An illustrative, non-limiting embodiment of the invention comprises a conveyor apparatus for moving articles, such as plant products, to be packed, including at least one pattern plate to stationarily hold the articles to be packed in a predetermined arrangement. The embodiment also comprises a plate movement mechanism for moving a plate laterally between a loading and an unloading position, wherein at least one pattern plate can be readily moved onto and removed from the plate movement mechanism, and whereby the articles are loaded onto the pattern plate at the loading position and unloaded from the pattern plate at the unloading position.

An illustrative, non-limiting embodiment of the present invention further relates to a plant product packing machine having a pick up head that picks up an organized or predetermined arrangement of plant product at once and places it into a package or carton, thus packing the plant product at a much faster rate. All of the plant products presented to a pick-up head on the pattern plate may be picked up at once, or, more generally, a plurality of fruit may be picked up at once and loaded into cartons.

An exemplary embodiment of the present invention utilizes a set of interchangeable plates with cavities into which plant products are loaded, including symmetrical and/or odd shaped fruit, and transported on a conveyor system. The assembled plant products may then be checked for proper loading and orientation with any of a variety of measurement devices, including machine vision devices, before being presented to a pick-up head on a packing machine.

This conveyor system lends itself well to quality evaluation and control system operations, such as those that utilize machine vision, for enhanced performance. A machine vision system can use cameras, sensors, bar codes, image processing software, etc., to perform inspection, such as counting, sizing and positioning objects on the conveyor. The machine vision system may work in tandem with knock off mechanisms, such as gates, brushes or arms that remove excess plant products from the plates. Such arrangements, as are known in the art, can be utilized to enhance automated loading, conveying and unloading. Additional performance evaluation devices can be used in conjunction with the conveyor system, including acoustic sensors, individual product sensitive detectors, and other quality control devices as are known in the art.

An exemplary embodiment of the conveyor system that forms a part of the present invention consists of two types of elements—fixed elements and interchangeable elements. The fixed elements comprise at least a frame, pulleys, belts, motors and air, electrical or hydraulic actuators, such as cylinders. Once the fixed elements are assembled, they do not need to be altered for changes in product size or package size, and hence may be termed “fixed.”

The interchangeable elements comprise pattern plates, which are easy to replace (i.e., readily replaceable), and need no, or only simple, tools to do so. Such plates may be made of a metal or plastic material, or a combination thereof, such that they are lightweight, easy to handle, easy to store in a packing facility, and easily formed with a pattern of plant product-holding cavities or indentations. The interchangeable elements are also much less expensive to manufacture than components in comparable packing machine feed systems, and yet are very durable, requiring no maintenance and infrequent replacement.

One exemplary embodiment of the present invention allows for interchangeability of pattern plates having different sized, shaped or arranged cavities, so that different size plant products can be packed into the same size carton or the same size product can be packed into different size cartons, or a combination of the two.

A further exemplary embodiment of the invention involves a method of transporting and presenting non-round or round plant products, such as fruit, to a pick up device on a packing machine which packs the plant product into cartons by layer. The device that implements the method may comprise a frame, a set of pulleys and belts within that frame, and a set of preformed pattern plates. The pattern plates may have preformed patterns of cavities or indentations to match the size of fruit and a desired organization of fruit for a given carton pack. According to the method, the pattern plates are loaded at a loading section at one end of the frame and are moved by engaging belts and sliding on a track to the other end having an unloading section proximate to a pick-up head of a packing machine. The plant products on a given pattern plate are picked up by the pick-up head, all together, in groups or one at a time. Thereafter, the empty pattern plate is transported back to the loading section. After arriving at the loading section, a movement mechanism, such as an air cylinder, lifts the empty pattern plate to the elevation of the feed side of the belt to repeat the cycle.

The product throughput can be adjusted by varying the speed of the conveyor and the pick-up head. There may also be pattern plate sensors at each end of the frame assembly to detect the arrival and positioning of the pattern plates. The pattern plates are easily changed out for different article sizes, article types, carton sizes, pack patterns, etc., while the frame remains in place, making the system very convenient to operate where the type of product and cartons are frequently changed during the pack day.

Plant products and similar articles that may be loaded with the conveyor system include fruits, vegetables, prepackaged products, or any other article that is to be loaded with other similar products or articles into a larger container in layers. Other means for moving the pattern plates include a simple roller device on an inclined plane where the pattern plate holds the articles in place while rolling down the inclined plane; magnetic levitation to suspend and propel the pattern plates; or a simple motor and gear system that moves the pattern plates from one end of the conveyor system to the other.

### BRIEF DESCRIPTION OF THE DRAWINGS

Features and advantages of illustrative, non-limiting embodiments of the present invention will become more apparent from a reading of the following description. The accompanying drawings, which are incorporated in and constitute a part of this specification, illustrate exemplary embodiments of the invention and, together with the description, serve to explain the aspects, advantages and principles of the embodiments. In the drawings:

FIG. 1 is a perspective view of a fruit conveyor used for transporting and presenting round and/or non-round fruit to a pick up device on a packing machine.

FIG. 2 is a flow chart of a method for conveying plant products or similar articles to a packing machine which packs fruit into cartons by layer.

FIG. 3 is an embodiment of a pattern plate.

FIG. 4 is a perspective view of an embodiment of the fruit conveyor in operation.

FIG. 5 is another embodiment of a pattern plate.

FIGS. 6A and 6B are side elevation view diagrams of the loading end of the conveyor system prior to loading the articles.

FIGS. 7A and 7B are side elevation view diagrams of the pick-up end of the conveyor system just before and just after unloading the articles, respectively

FIG. 8 is an end view at the loading end, illustrating the several possible vertical stations for the patter plate lifting platen.

### DETAILED DESCRIPTION OF THE ILLUSTRATIVE, NON-LIMITING EMBODIMENTS OF THE INVENTION

Illustrative, non-limiting embodiments of the present invention will now be described more fully with reference to the accompanying drawings.

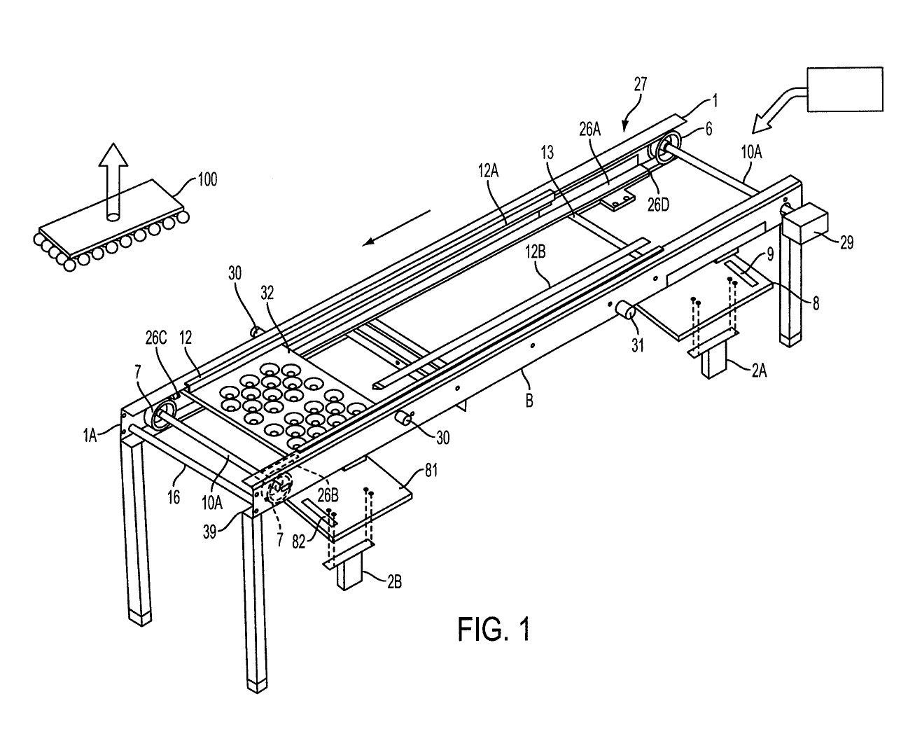

This invention relates to a conveyor system used for transporting and presenting both round and non-round plant products, such as fruit, vegetables or other articles, to a pick-up device on a packing machine which packs the articles into cartons by layer. Referring to FIG. 1, the device comprises a frame 1, two sets of pulleys 6, 7, two belts 26A, 26B within the frame 1, each belt being rotatable around pulleys in a set, respectively, and a plurality of preformed pattern plates 32. As would be understood by those skilled in the art, there may be two or more pulleys for each belt and one or more belts, although two are shown in the exemplary embodiment. The belts are oriented vertically and have a top section 26C and a bottom section 26D. A vertical orientation is preferred over a horizontal conveyor arrangement because the vertical arrangement permits a reduced foot print for the conveyor system that requires less floor space, permits more flexible assembly and disassembly, and permits a more flexible orientation on a packing house floor.

In further detail, with reference to FIG. 1, the frame comprises two opposing C shaped channels 1A and 1B that are connected by cross members 13, 16. Pulleys 6, 7 are mounted on shafts 10A and 10B, respectively, and may be disposed inside the C shape of channels 1A and 1B of frame member 1. Flexible belt members 26A, 26B are then mounted onto the pulley pairs 6, 7 within the frame member 1. A coupling is used to connect one drive shaft 10B to a drive motor 29. The drive motor 29 can drive the conveyor system at variable speeds. Preferably, the motor is intermittently driven and the belts 26A, 26B are also intermittently rotated, although a continuously driven motor, including one with a clutch or engagement/disengagement mechanism, also could be used.

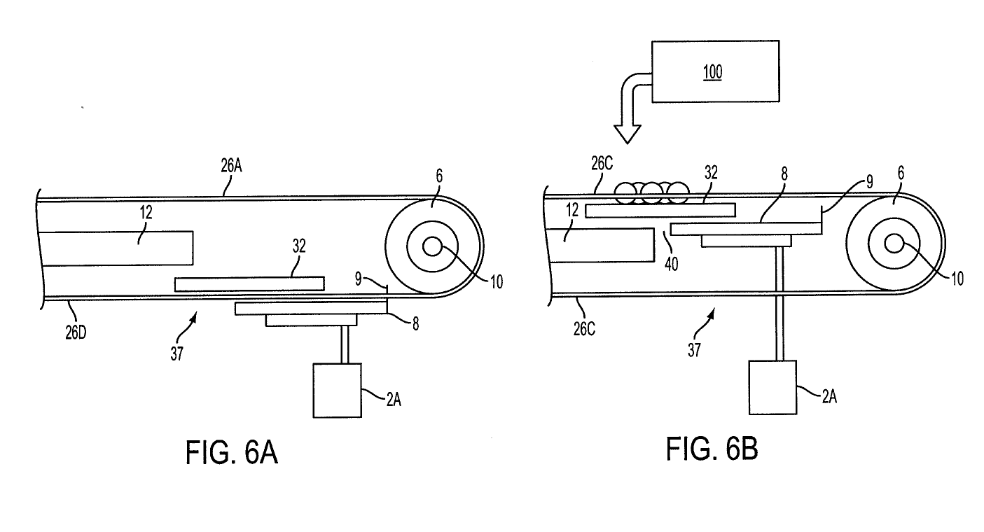

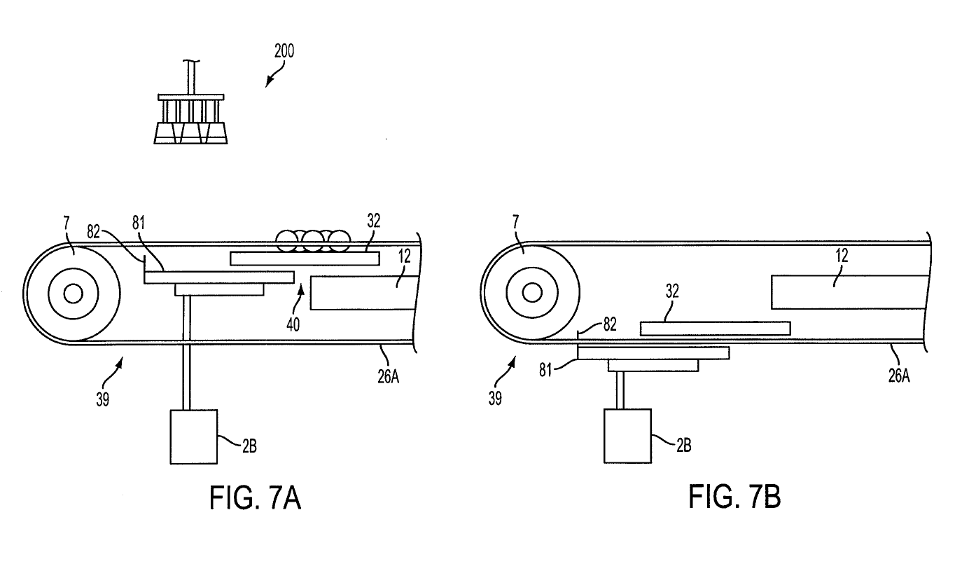

A pair of L-shaped or C-shaped tracks 12A and 12B are provided in a spaced apart manner in parallel with the belts 26 and with a distance between them adequate to contain the plates in a lengthwise direction and to guide the plates as they are moved by engagement with the belts 26A, 26B from the loading section to the unloading section. Guide tracks maintain the equal spacing of belts 26A, 26B through the entire length of frame 1. The tracks also provide substantially equal contact pressure between the belts 26A, 26B and the pattern plates 32. At the two opposite ends of the conveyor system are platens 8, 81. Each platen 8, 81 is attached to an air cylinder 2A, 2B, respectively (see FIGS. 6A, 6B, 7A and 7B for added detail), or other electrical, hydraulic or mechanical motive mechanism that is mounted beneath the frame assembly for elevation purposes. Pattern plates 32 are then inserted into the assembly through a cutout in the side of one frame member or through the top of the assembly. In the illustrated embodiment, the pattern plates 32 are positioned on the top side of the bottom section 26D of the belts or against the underside of the top section 26C of the belts.

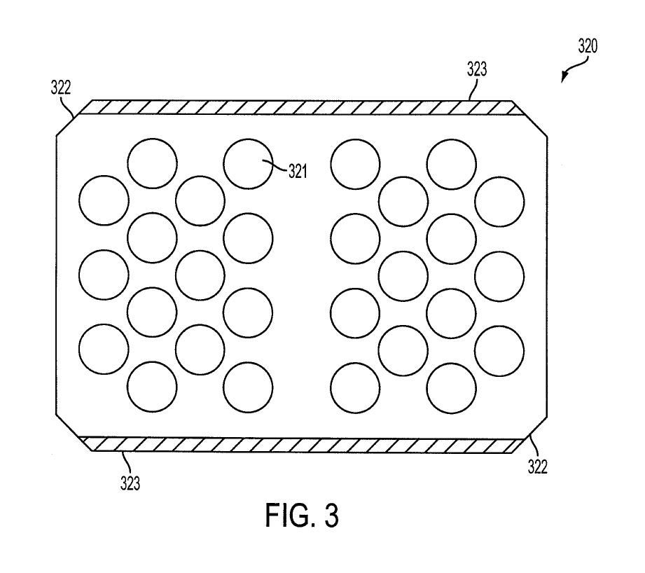

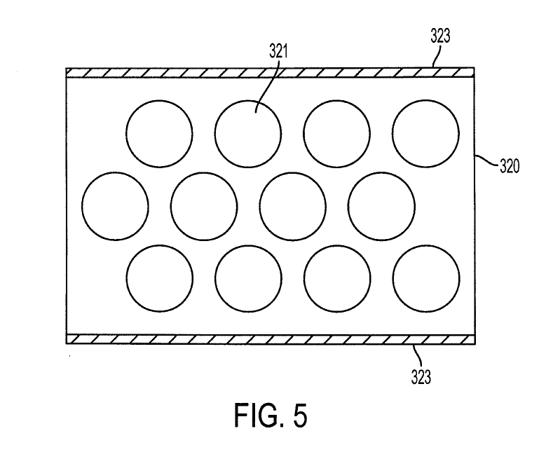

The plates 32 have preformed patterns that match the size, shape and desired organization of the plant product or other article for a given carton pack. For example, FIGS. 3 and 5 show preformed pattern plates 320 having twenty-eight cavities 321 and twelve cavities 321, respectively. The shape and size of the cavities 321 can vary depending on the shape and size of the plant product to be loaded. The number of cavities 321 and their layout on the pattern plate 320 also can vary depending upon the carton into which the plant product is to be loaded, as illustrated in FIGS. 3 and 5. The pattern plate 320 also can have cut corners 322 to allow for quick removal from the conveyor when multiple pattern plates are adjacent to one another. The pattern plate 320 can be made of materials such as resin, foam, polyethylene, or multiple materials such as foam with aluminum or another metal on the outer edges. Finally, the pattern plates may have a belt engaging surface 323 that is textured or has a composite material or coating that permits engagement with the moving belts 26A, 26B, and a track engaging surface or material that permits low resistance sliding of the plate along the tracks 12A, 12B.

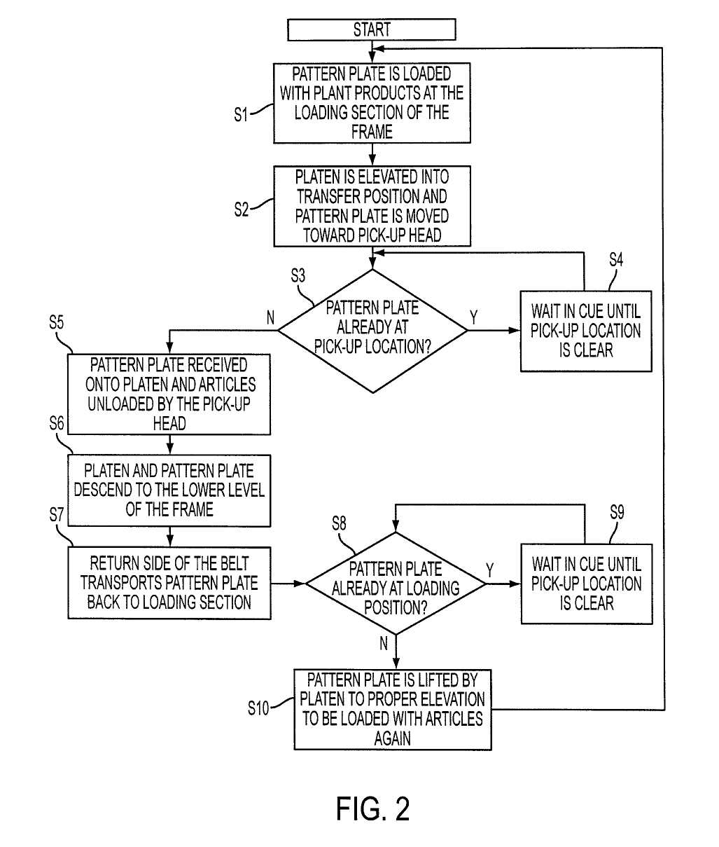

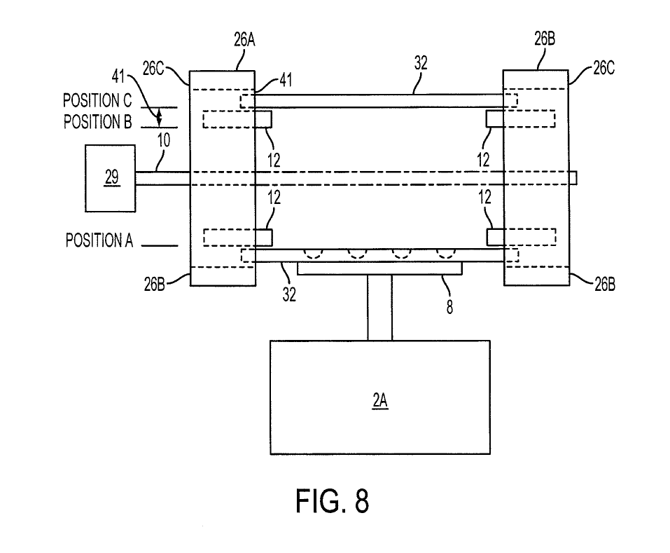

FIG. 2 is a flow chart of one embodiment of the method of conveying plant products or similar articles to a packing machine which packs the products or articles into cartons by layer after being conveyed by the system illustrated in FIG. 1. According to an exemplary embodiment of the method, at the start, an empty pattern plate 32 is loaded with articles at the loading end 37 of the frame 1 in step S1. Loading from a source of plant products 100 is preferably performed after the pattern plate 32 is elevated by platen 8 to the underside of the top section 26C of the belts 26A, 26B. Alternatively, the pattern plate 32 may be loaded while resting on the top side of the bottom section 26D of the belts 26A, 26B. The platen 8 may elevate the pattern plate 32 from an arrival position A to a loading position B just below belts 26A, 26B, allowing a clearance 41 (FIG. 8) between the bottom side of the top portion 26C of belts 26A, 26B and pattern plate 32 so that belts 26A, 26B do not engage and thus frictionally move pattern plate 32 off the platen 8. After loading the articles onto the pattern plate 32, the full pattern plate 32 may be elevated further to a transfer position C by platen 8 so as to frictionally engage belt 26. As the belts 26A, 26B frictionally engage pattern plate 32, the pattern plate 32 slides off platen 81 and into a region 40 between the stationary track 12 and the belts 26 at step S2. Track 12 keeps the pattern plate 32 frictionally engaged with the belts 26A, 26B so as to keep the pattern plate 32 moving down the conveyor system toward the unloading (i.e., pick-up) section 39. Alternatively, the plate may be moved directly from position A to transfer position C without stopping at a position B.

The tracks 12 may be treated so as to have a lubricated or reduced friction upper surface so that the pattern plate 32 may easily slide over the top of it without wearing away the pattern plate 32. Additionally or alternatively, tracks 12 may incorporate bearings or other similar components to allow pattern plate 32 to easily slide from one end of the conveyor system to the other. At step S3, it is determined whether there is a pattern plate already at the pick up location. If there already is a pattern plate 32 at the unloading section 39, actuators such as air cylinders 30 or electrical solenoids extend a stopping member to prevent advancement of the next pattern plate 32 and the plate(s) 32 wait in a queue in step S4 until the platen 81 is clear. If the belts 26A, 26B are moving, they and simply slide over the top surface of the pattern plate, and the pattern plates can queue up and be released upon command.

If there is no pattern plate 32 at the unloading section 39, the pattern plate 32 moves out of the region 40 between the track 12 and belt 26 and onto a platen 81 at the unloading section 39. Once situated on the platen 81, the pattern plate 32 is lowered to the top side of the bottom section of the belts 26A, 26B by operation of any of an air cylinder, motor and gear assembly, or similar hydraulic, electrical, or mechanical devices 2B as shown in step S6. The pick-up head 200, which is part of the packing machine—both of which may be integral with the conveyor system—then unloads the articles off the pattern plate 32 and into cartons or similar packages in step S5. After unloading, at step S5, the pattern plate, at step S7, is moved off of the platen 81 by frictionally engaging the upper side of the bottom section of the belts 26A, 26B and are conveyed back toward the loading end 37.

At step S8, it is determined if there is already a pattern plate 32 on the platen 8 at the loading end 37. If so, in step S9, two small air cylinders 31 horizontally mounted on the sides of the frame 1 at the loading end 37 extend to prevent the next empty pattern plate 32 from moving into the loading position. If there is no pattern plate 32 already at the loading end 37, the pattern plate 32 moves onto the platen 8 at the loading end 37 and engages a guard 31, which is connected to the platen 8. In step S10, the pattern plate 32 and platen 8 are then elevated to the proper elevation for loading by any of an air cylinder, motor and gear assembly, or similar hydraulic, electrical, or mechanical devices 2A, as are known in the art.

The foregoing cycle of loading and unloading can be continuous, and the process returned to the start, so long as there is a supply of plant product for packing, or can be momentarily interrupted in order to replace one or more of the pattern plates with other pattern plates. Multiple pattern plates are used on the conveyor at the same time, and the plates 320 may vary in type or orientation of their cavities 321. This allows for multiple types of articles to be loaded at the same time, or for example, different complementary layers of the same type of article in a carton. Such a feature, may require multiple feeder systems to feed different types of articles to the loading end of the conveyor. The concurrent use of multiple plates also allows the same product to be loaded with different patterns in the same carton. Presenting articles to the pick-up head 200 of the packing machine in an organized manner on pattern plates reduces the required complexity of the pick-up head 200 and its related sensors, and also the time required to load the articles into containers. The plates can be bar coded for detection by an imager at various locations along the path of travel, and appropriate controls or adjustments can accordingly be made, as would be programmed by one skilled in the art.

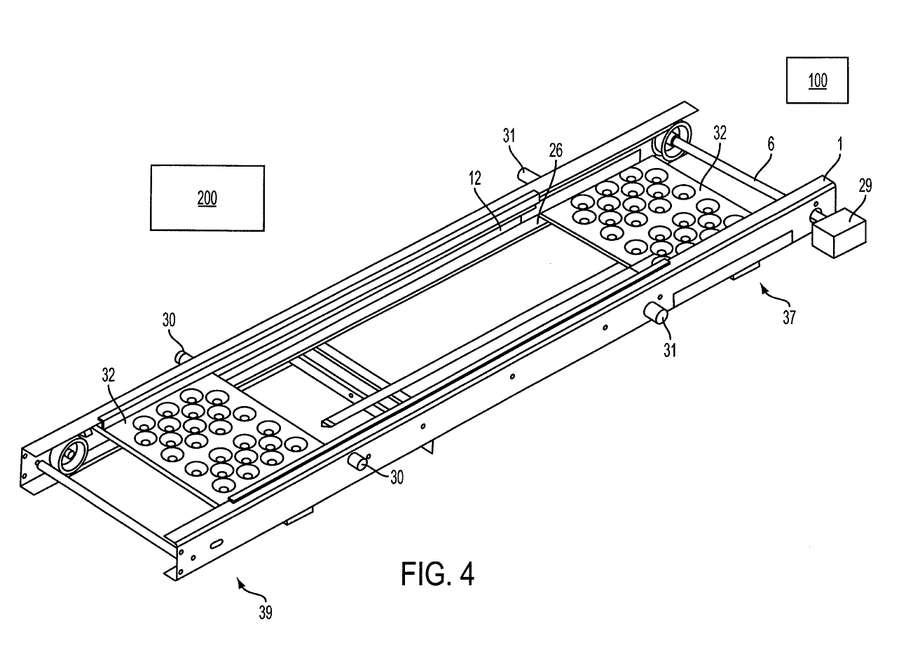

Referring to FIGS. 2 and 4, the pattern plate 32 is loaded at the loading end 37 of the frame and is moved by engaging the bottom side of the top portion 26C of the belts 26A, 26B and sliding on top of the track 12 to the pick-up end 39 where the pick-up head 200 of the packing machine loads the articles into cartons (not shown). Once the articles are unloaded from the pattern plate 32 by the pick-up head 200, the platen 81 carrying empty pattern plate 32 descends to the lower level of the frame 1 to allow the pattern plate 32 to engage the top side of the bottom portion 26D of the belts 26A, 26B and the pattern plate 32 is transported back to the loading end 37. Upon arrival at the loading end 37, the empty pattern plate 32 is moved over platen 8 and an air cylinder 2A (FIG. 6A) lifts platen 8 with the empty pattern plate 32 to the elevation of the bottom side of the top portion 26C of the belts 26A, 26B to repeat the cycle. The pattern plates 32 are easily changed out to accommodate different fruit sizes, carton sizes, and pack patterns while the frame 1 remains in place, making the system very convenient to operate where the type of articles or cartons are frequently changed throughout the packing day.

In operation, the drive motor 29 rotates the drive shaft 10 causing the pulleys 6, 7 to rotate and hence causing the left and right belts 26A, 26B to move in unison. The pattern plates 32 on the bottom side of the top portion 26C of belts 26A, 26B move on the belt system from the loading end 37 to the pick-up end 39, along a path defined by the tracks 12. Once a full pattern plate 32 is moved into position, sensors (not shown) generate a signal that is detected by the main packing machine computer-based control system. The computer in the control system includes programming that responds to the detected signal and causes the pick-up head 200 to descend to close proximity of the articles. Then, using vacuum or suction cups, or an equivalent method and apparatus, the pick-up head 200 lifts and removes a plurality, and possibly all, of the articles from the pattern plates for placement into the carton.

The main computer of the packing machine then signals the conveyor system to index another full pattern plate 32 into position, where it engages a guard 82 on platen 81. When this signal occurs, two small air cylinders 30 horizontally mounted on the sides of the frame 1 at the pick-up end 39 extend to prevent the next fully loaded pattern plate 32 from moving into the pick-up head position. The air cylinder 2B on the pick-up end 39 lowers the platen 81 with the empty pattern plate 32 to the return side of the belts 26A, 26B. The empty pattern plate 32 is then transported to the loading end 37 of the frame assembly. Once the empty pattern plate 32 leaves the pick-up platen 81, the pick-up platen 81 is raised back to its elevated position to support an arriving full pattern plate 32. The hold-back air cylinders 30 then retract, allowing another fully loaded pattern plate 32 to move onto the platen 81 and engage guard 82 at the pick-up head position.

When the empty pattern plate 32 arrives on the return side of the belt at the loading end 37 of the frame assembly, sensors (not shown) signal the computer-based controller that the empty pattern plate 32 is in position over platen 8. The empty pattern plate 32 is then elevated to the bottom side of the top portion 26C of the belts 26A, 26B by a loading end air cylinder 2A which raises its respective platen 8. Once the empty pattern plate 32 is elevated to a first vertical position, it is then loaded with the plant product or other articles. One loaded and checked, the plate is moved to a second vertical position, which causes engagement with the belts and movement of the plates along the track 12 toward the pick-up end 39. Then, the loading end platen 8 descends to accept a new arriving empty pattern plate 32. When the loading end platen 8 rises, the cylinders 31 extend to prevent other empty pattern plates 32 from moving forward, thus queuing up the empty pattern plates 32 on the return side of the belt system.

Signals to control the conveyor system are synchronized with a feed system that feeds articles to be loaded to the conveyor system, preferably with a common computer-based controller, so that at no time is the feed system attempting to load articles onto the pattern plates 32 while an empty pattern plate 32 is not in rest position ready to accept the articles.

The conveyor system works in conjunction with a packing machine. Additional units can also be used in conjunction with the conveyor system, including a presorting unit where articles are sorted according to type, size, or quality, the poor quality articles being discarded; a washing unit where the articles may be brushed and rinsed free of dirt or potential fungus; a drying unit to remove any water from the surface of the articles; an ethylene application unit to promote quick ripening of articles, e.g. fruits; a waxing unit to apply a thin layer of wax on the articles to prevent parasites from feeding or surviving on the articles; or other useful devices as are known in the art.

Although the invention has been explained in relation to certain exemplary and preferred embodiments, it is to be understood that many other possible modifications and variations can be made without departing from the spirit and scope of the invention as hereinafter claimed.

What is claimed is:

1. A plant product conveying apparatus for moving plant products to be packed, comprising:
at least one pattern plate structured with recesses, depressions, or holes, each recess, depression, or hole operative to stationarily hold one of a plurality of plant products, arranged in an array for packing said plant products;
a plate movement mechanism for moving a plate laterally between a loading position and an unloading position;
first moving means at said loading position for moving the at least one pattern plate onto the plate movement mechanism; and
second moving means at said unloading position for unloading the at least one pattern plate.

2. The conveyor apparatus of claim 1, said first moving means further comprising means for vertically moving the at least one pattern plate between at least a first height for engaging a pattern plate and a second height for disengaging a pattern plate.

3. The conveyor apparatus of claim 1, said second moving means further comprising means for vertically moving the at least one pattern plate between at least a first height for engaging a pattern plate and a second height for disengaging a pattern plate.

4. The conveyor apparatus of claim 1, wherein the at least one pattern plate has a preformed pattern that matches a specific size and/or shape of plant product.

5. The conveyor apparatus of claim 1, wherein the plate movement mechanism comprises at least one belt for moving said plate and at least one track for guiding said plate.

6. The conveyor apparatus of claim 2, wherein the first moving means comprises a platen and an actuator coupled to the platen.

7. The conveyor apparatus of claim 3, wherein the second moving means comprises a platen and an actuator coupled to the platen.

8. The conveyor apparatus of claim 6, wherein the actuator comprises at least one of a hydraulic, mechanical and electrical actuator.

9. The conveyor apparatus of claim 7, wherein the actuator comprises at least one of a hydraulic, mechanical and electrical actuator.

10. The conveyor apparatus of claim 1 further comprising a computer-based controller coupled to said plate moving mechanism, said first moving means and said second moving means for detecting operation and controlling operation thereof.

11. The conveyor apparatus of claim 11 further comprising gates, proximate to said first moving means and said second moving means, and operating under control of said computer-based controller, for delivering plates one by one.

12. A conveyor apparatus for moving plant products to be packed, comprising:
a plurality of pattern plates structured with recesses, each recess operative to stationarily hold one of a plurality of plant products, arranged in an array for packing said plant products;
a plate movement mechanism for moving a plate between a loading position and an unloading position, said mechanism comprising at least one belt for conveying said plates and a motorized drive to move said at least one belt;
first vertical moving means at said loading position for moving the at least one pattern plate onto the at least one belt;
second vertical moving means at said unloading position for unloading the at least one pattern plate from the at least one belt; and
unpacking means disposed at unloading positions for unloading the plant products from the pattern plates into cartons.

13. The conveyor apparatus of claim 12, wherein the pattern plates are individually elevated to an underside of a top section of the belt at the loading position, and lowered to a top side of a bottom section of the belt at the unloading position.

14. A method of conveying plant products to a packing machine, comprising:
providing a pattern plate for loading, said pattern plate being structured with recesses, each recess operative to stationarily hold one of a plurality of plant products, arranged in an array for packing said plant products;
filling a pattern plate with plant products to be packed,
loading the pattern plate onto a horizontal conveying means at a loading position;
moving the pattern plate, while holding the plant products to be packed, from the loading position to an unloading position;
unloading the plant products from the pattern plate; and
moving an empty pattern plate from the unloading position back to the loading position.

15. The method of claim 14, wherein the plant products to be packed are fruits or vegetables, the method further comprising replacing a first type pattern plate with a second type pattern plate to suit a change in size or shape of a plant product to be packed.

16. The method of claim 14, wherein the moving step between the loading position and unloading position is conducted by at least one moving belt.

17. The method of claim 16, wherein the loading step further comprises moving a pattern plate from a first vertical position to a second vertical position at a delivery side of the belt and the unloading step further comprises moving a pattern plate from a second vertical position to the first vertical position at a return side of the belt.

18. The method of claim 17, wherein the delivery side is one of a top side and a bottom side of the belt, and the return side is the other of the top side and the bottom side of the belt.

19. The method of claim 14, further comprising packing said plant product in containers upon unloading.
